(19) United States
(12) Patent Application Publication
(10) Pub. No.: US 2016/0277498 A1
(43) Pub. Date: Sep. 22, 2016

(54) LOCATION AND BOUNDARY CONTROLS FOR STORAGE VOLUMES

(71) Applicant: Intel Corporation, Santa Clara, CA (US)

(72) Inventors: SAURABH KULKARNI, Santa Clara, CA (US); NARESH K. GADEPALLI, Santa Clara, CA (US); YELURI RAGHURAM, San Jose, CA (US)

(73) Assignee: INTEL CORPORATION, Santa Clara, CA (US)

(21) Appl. No.: 14/709,295

(22) Filed: May 11, 2015

Related U.S. Application Data
(60) Provisional application No. 62/136,134, filed on Mar. 20, 2015.

(51) Int. Cl. H04L 29/08

(52) U.S. Cl. CPC H04L 67/1097; H04L 67/2852

(57) ABSTRACT

This disclosure describes, in one embodiment, a system that includes a block storage and virtual machine (VM) manager to identify one or more storage node(s) that meet at least one policy constraint and to select a storage node with capacity from the one or more storage node(s) that meets all of the at least one policy constraints, the at least one policy constraint related to a respective geolocation of each of the identified storage node(s).

### CROSS-REFERENCE TO RELATED APPLICATION(S)

This application claims the benefit of U.S. Provisional Application No. 62/136,134, filed Mar. 20, 2015, the teachings of which are incorporated herein by reference in their entirety.

### FIELD

The present disclosure relates to policy compliant data handling in network systems.

### BACKGROUND

Data security, governance and compliance to regulations/policies is a critical requirement in data centers. The agility and flexibility of Cloud computing make it difficult to enforce these requirements easily. Even when applications are controlled, the applications can access data and/or map to data volumes that violate these regulations and policies. In the current state of the art, boundary conditions may be set for virtual machine instances, such that a virtual machine (VM) may only be provisioned within a certain geographical boundary as set by a policy. However, storage devices have no such limitations.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a network system consistent with various embodiments of the present disclosure;

FIG. 2 illustrates a trust and geolocation example according to one embodiment of the present disclosure;

FIG. 3 illustrates a flowchart of storage volume create operations according to one example embodiment consistent with the present disclosure;

FIG. 4 illustrates a flowchart of storage volume attach operations according to one example embodiment consistent with the present disclosure; and

FIG. 5 illustrates a flowchart of migration operations according to one example embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides methods and systems for implementing geographical location (“geolocation”) constraints for storage volumes created in block storage nodes in a cloud computing environment. The methods and systems are configured to allow provisioning of block storage on server system(s) that comply with given geolocation constraint(s) and to return an error if no such server system(s) are available or if a specified server system fails to comply with the given geolocation constraint. The geolocation constraints may be included in or provide all or a portion of one or more policies governing the generation or creation of storage volumes on network server systems. For example, the geolocation constraints may be related to a geolocation associated with a virtual machine (VM) node that has requested block storage. In another example, the geolocation constraints may be related to a policy-defined geolocation constraint. The geolocation of a storage device or server system hosting a storage volume, storage node, or VM node may be identified using a geolocation identifier included in an asset tag that is protected by cryptographic techniques including a digital signature, hashing, secure storage, or combinations thereof. The methods and systems are further configured to verify a trust status of each of the block storage nodes, as described herein.

A geolocation may be specified using data indicative of at least one of: a street address, a plurality of street addresses that together form a boundary, a town, a city, a state, a province, a country, a geographic area (e.g., a group of states), a continent, a range of GPS (global positioning system) coordinates, a range of latitude and longitude values, etc. In other words, a geolocation corresponds to a boundary of a geographic region. Each geographic region may be identified by a range of values and/or a geographic identifier. A server system, storage volume, storage node, or VM node located within the geographic region may then be understood to satisfy the associated geolocation constraint. Such geolocation constraints are configured to ensure that information including, for example, data that is stored in a storage volume at a storage node is located within the specified geographic region. Thus, a storage location of sensitive data may be controlled.

A system that provides a storage volume compliant with workload boundary and location requirements may include a network that having a number of storage devices communicably coupled thereto. Each of the storage devices may host at least one storage node. A processor may also be communicably coupled to the network. The processor receives a request generated by at least one network connected device to create a storage volume on a storage node, the request including at least one storage volume parameter and at least one policy criterion provided by an initiator of the request. The processor may further identifies a number of communicably coupled storage devices that host at least one candidate storage node that fulfills the at least one storage volume parameter. The processor may determines a value indicative of a level of trustworthiness and a value indicative of a level of policy compliance of at least some of the storage devices that host the identified candidate storage nodes to provide a number of candidate storage nodes. The processor may further identifies from the number of candidate storage nodes at least one destination storage node hosted by a storage device that fulfills the at least one policy criteria and create the storage volume on the storage device that hosts the at least one destination storage node and that fulfills the at least one policy requirement.

A method that provides compliance with workload boundary and location requirements may include receiving, by a processor, a request to create a storage volume on a storage node, the request including at least one storage volume parameter and at least one policy criteria logically associated with an initiator of the request. The method may further include identifying, by the processor, a number of candidate storage nodes meeting the at least one storage volume parameter. The method may further include determining, by the processor, a value indicative of a level of trustworthiness and a value indicative of a level of policy compliance of at least some of the storage devices hosting the candidate storage nodes to identify at least one trusted, policy compliant, storage device. The method may further include identifying, by the processor at least one trusted, policy compliant, storage device hosting at least one of the number of candidate storage nodes. The method may additionally include creating, by the processor, the storage volume at the storage node hosted by the at least one trusted, policy compliant, storage device.

A storage device may contain machine readable instructions that when executed by a processor, cause the processor to receive a request to create a storage volume on a storage node, the request including at least one storage volume parameter and at least one policy criteria logically associated with an initiator of the request. The instructions may further cause the processor to identify a number of candidate storage nodes meeting the at least one storage volume parameter. The instructions may further cause the processor to determine a value indicative of a level of trustworthiness and a value indicative of a level of policy compliance of at least some of the storage devices hosting the candidate storage nodes to identify at least one trusted, policy compliant, storage device. The instructions may further cause the processor to identify at least one trusted, policy compliant, storage device hosting at least one of the number of candidate storage nodes and create the storage volume at the storage node hosted by the at least one trusted, policy compliant, storage device.

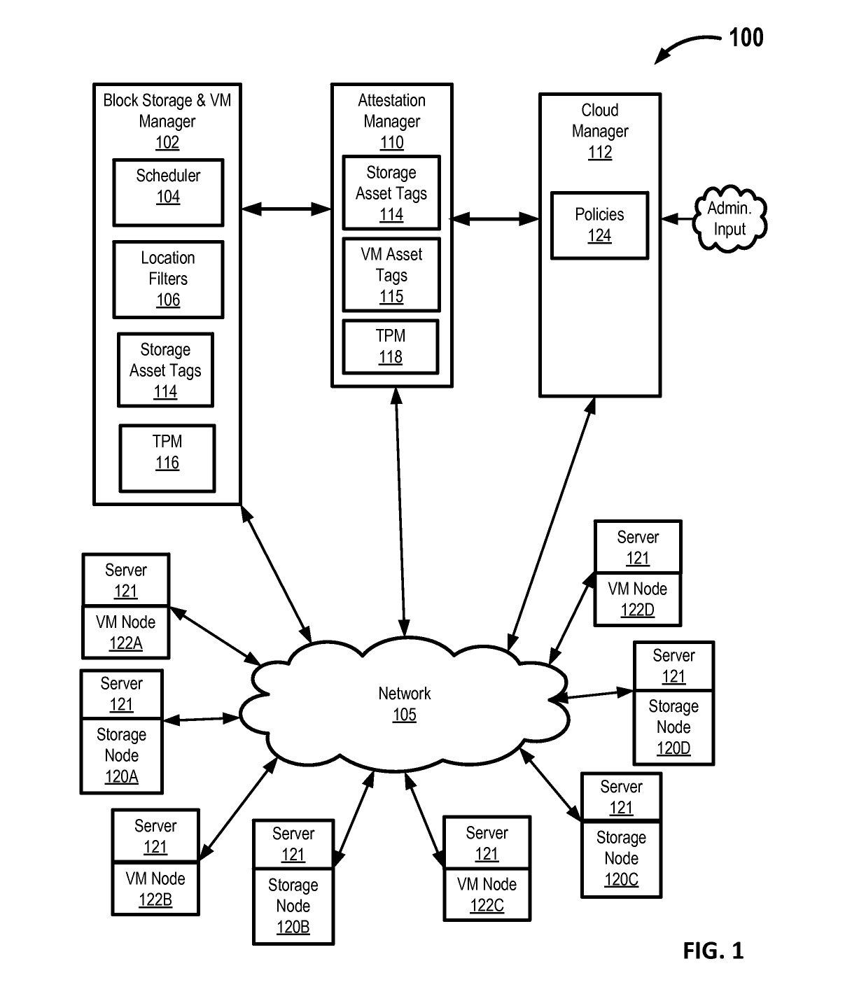

FIG. 1 illustrates a network system 100 consistent with various embodiments of the present disclosure. The network system 100 may form at least part of a cloud-based data center, high-performance computing center, etc. Network system 100 generally includes a block storage and virtual machine (VM) manager 102, an attestation manager 110, a cloud manager 112, a plurality of geographically dispersed storage devices or server systems 121, each hosting one or more storage nodes 120A, 120B, 120C and 120D (referred collectively herein as “storage nodes 120”), and a plurality of geographically dispersed storage devices or server systems 121, each hosting one or more virtual machine (VM) nodes 122A, 122B, 122C, 122D (referred collectively herein as “VM nodes 122”), all in communication via network 105. Each of these components of the network system 100 may be formed of one or more server systems operating on the network 105, and each of these components may generally comply or be compatible with the OpenStack® Cloud Computing Platform including, for example, block storage platforms, VM platforms, cloud management platforms, etc.

While the block storage and VM manager 102 and attestation manager 110 are depicted as separate server systems in FIG. 1, it is understood that these components of network system 100 may be collocated or formed within a single server system. The block storage and VM manager 102 is generally configured to manually or autonomously create VM instances on the VM nodes 122. The block storage and VM manager 102 is generally configured to manually or autonomously create, attach and/or migrate storage volumes on the storage nodes 120. VM node(s) 122 and/or storage node(s) 120 may further be manually or autonomously created and/or accessed via one or more application programming interface(s) (APIs).

The cloud manager 112 is generally configured to provide a user interface, for example, an administrator “dashboard”, that may be used to monitor operation of network system 100, set policies 124, request creation of VM node(s) 122 and/or request creation of storage volume(s) or storage node(s) 120 hosted by one or more server systems 121 in the network system 100.

Block storage and VM manager 102, attestation manager 110, cloud manager 112, VM node(s) 122A, 122B, 122C and/or 122D and/or storage node(s) 120A, 120B, 120C and/or 120D may be implemented on one or more storage devices, server system(s), or similar 121. In other words, each server system 121 may correspond to a platform that includes a processor, memory, a network interface, etc. Server systems 121 may include, but are not limited to, a workstation computer, a desktop computer, a laptop computer, a tablet computer (e.g., iPad®, GalaxyTab® and the like), an ultraportable computer, an ultramobile computer, a netbook computer and/or a subnotebook computer, a mobile telephone including, but not limited to, a smart phone, (e.g., iPhone®, Android®-based phone, Blackberry®, Symbian®-based phone, Palm®-based phone, etc.), etc. At least one server system 121 may include one or more peripheral device(s), including, but not limited to, user input device(s) (e.g., keyboard, touchscreen, touch pad, etc.) and/or user output device(s) (e.g., display, printer, etc.). Thus, each server system 121 may be defined by its associated configuration (e.g., VM node, storage node) and one server system 121 may include one or more storage node(s) 122, one or more WM nodes 120, or any number or combination thereof.

Block storage and VM manager 102 may include scheduler 104, location filter(s) 106, storage asset tag(s) 114, a trusted platform module (TPM) 116, or combinations thereof. Attestation manager 110 may include storage asset tag(s) 114, VM asset tag(s) 115, a trusted platform module (TPM) 118, or combinations thereof. Cloud manager 112 may include policies 124.

Attestation manager 110 is configured to generate storage asset tags 114 and to provision a respective storage asset tag 114 to each server system that includes (e.g., hosts) a storage node, e.g., storage node 120A, 120B, 120C and/or 120D. Attestation manager 110 may be further configured to generate VM asset tag(s) 115 and to provision a respective VM asset tag to each server system that includes (e.g., hosts) a VM node, e.g., VM node 122A, 122B, 122C and/or 122D.

Attestation manager 110 may, at times, include a trust authority service. In embodiments, a trust authority service may be configured to verify the trustworthiness and/or geographic location (e.g., geo-location such as town, city, state, country, continent, geopolitical boundary, range of global positioning coordinates, range of longitude and latitude, and similar) of the storage devices or server systems 121 hosting, storing, or otherwise retaining the various storage nodes 120, VM nodes 122, or combinations thereof.

In some embodiments, in addition to the geo-location of a server system 121 hosting or otherwise storing a particular storage node 120 or VM node 122, the trust authority service may determine a value indicative of or otherwise attesting to one or more other parameters such as the trustworthiness (or lack thereof) of a particular storage node 120 or VM node 122. For example, the trust authority service may receive attestation requests from one or more entities such as the block storage and VM manager 102 or the cloud manager 112. In such instances, the trust authority service may conduct a trust analysis with respect to a particular server system 121 hosting all or a portion of a specific storage node 120 or VM node 122, and return a value indicative of the trustworthiness of the storage device or server system 121. At times, the attestation handler may use one or more application programming interfaces (APIs) to receive attestation requests from the in block storage and VM manager 102 or the cloud manager 112 and output the trustworthiness or geolocation verification results to the block storage and VM manager 102 or the cloud manager 112.

At times, the trust authority service may receive digitally signed communications from the block storage and VM manager 102 or the cloud manager 112. In embodiments, a certificate authority may be used to verify digital signatures logically associated with the block storage and VM manager 102 or the cloud manager 112. In addition, the illustrated trust authority service may include a trust verifier that is configured to conduct the trust analysis on a per-storage node or a per-VM node basis rather than a per-server basis. For example, the trust verifier may select a protocol specific plug-in from a plurality of protocol specific plug-ins and use the selected protocol specific plug-in to conduct a trust analysis of one or more storage nodes 120 or VM nodes 122. In particular, the digitally signed values received from such nodes may include platform configuration register (PCR) values such as geo-location values, software hashes (e.g., SHA-Hash values), integrity measurement log (IML) values such as measurement sequence and boot log information, etc., wherein the trust analysis may involve comparing the digitally signed values with one or more known values.

The trust authority service may be implemented on, for example, a personal computer (PC), server, workstation, laptop, personal digital assistant (PDA), wireless smart phone, media player, imaging device, mobile Internet device (MID), any smart device such as a smart phone, smart tablet, and so forth, or any combination thereof. Thus, the trust verifier, attestation server logic and certificate authority may incorporate certain hardware elements such as, for example, a processor, controller and/or chipset, memory structures, busses, etc. In addition, the illustrated trust authority service uses a network interface to exchange communications with the block storage and VM manager 102 or the cloud manager 112, as appropriate. For example, the network interface may provide off-platform wireless communication functionality for a wide variety of purposes such as, for example, cellular telephone (e.g., Wideband Code Division Multiple Access/W-CDMA (Universal Mobile Telecommunications System/UMTS), CDMA2000 (IS-856/IS-2000), etc.), Wi-Fi (Wireless Fidelity, e.g., Institute of Electrical and Electronics Engineers/IEEE 802.11-2007, Wireless Local Area Network/LAN Medium Access Control (MAC) and Physical Layer (PHY) Specifications), LR-WPAN (Low-Rate Wireless Personal Area Network, e.g., IEEE 802.15.4-2006), Bluetooth (e.g., IEEE 802.15.1-2005, Wireless Personal Area Networks), WiMax (e.g., IEEE 802.16-2004, LAN/MAN Broadband Wireless LANS), GPS (Global Positioning System), spread spectrum (e.g., 900 MHz), and other RF (radio frequency) telephony purposes. The network interface may also provide off-platform wired communication (e.g., RS-232 (Electronic Industries Alliance/EIA), Ethernet (e.g., IEEE 802.3-2005), power line communication (e.g., X10, IEEE P1675), USB (e.g., Universal Serial Bus, e.g., USB Specification 3.0, Rev. 1.0, Nov. 12, 2008, USB Implementers Forum), DSL (digital subscriber line), cable modem, T1 connection, etc., functionality.

After provisioning, during operation, asset tags 114, 115 may be used to determine whether or not a server system 121 and, consequently, any associated storage node 120 or VM node 122 hosted by the respective server system 121 is trusted or trustworthy and may also be used to determine the geolocation of the server system 121 using a geolocation identifier included in the asset tag 114, 115. Asset tags 114, 115 may be stored in secure storage, in or related to TPM 118, included in attestation manager 110. For example, when a server system 121 is powered up (i.e., booted), a stored asset tag 114, 115 may be compared to a corresponding server system value determined after power up. If the stored asset tag and the server system value match, then the server system may be trusted. If the stored asset tag and the server system value do not match, then the server system 121 is not trusted and a trust error may be generated.

For example, when a server system 121 boots, a trust module (e.g., Trusted Execution Technology (TXT) from Intel® Corp., Santa Clara, Calif., USA), utilizing for example, a TPM and cryptographic techniques, is configured to provide measurements of software (e.g., an operating system (OS)) and platform components that may then be used to verify the authenticity of a platform and its OS. If the authenticity is verified then the server system 121 is trusted and if the authenticity is not verified then the server system 121 is not trusted. An attestation may be performed, for example, by attestation manager 110. For example, attestation manager 110 may be configured to receive the measurements and geolocation value(s) from the server system 121 via net, to hash the measurements and geolocation value(s) and to determine whether the hash result correspond to a selected stored asset tag.

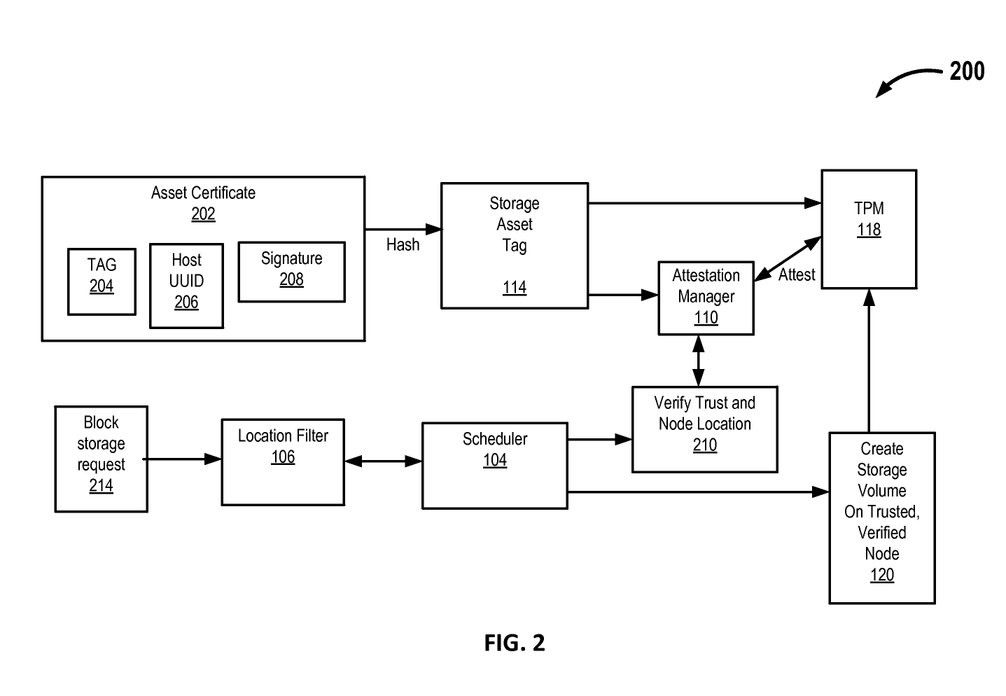

FIG. 2 illustrates a trust and geolocation example 200, according to one embodiment of the present disclosure. Trust and geolocation example 200 illustrates one example of generation of a storage asset tag and verification of trust and geolocation of a storage device or server system 121. At times, storage asset tag 114 may be generated from a hash of an asset certificate 202. The asset certificate 202 includes TAG 204, host UUID 206 and signature 208. TAG 204 includes data representative of a geolocation identifier, geolocation value(s), or any combination thereof. For example, a geolocation identifier may correspond to a group of geolocation values, codes, acronyms, or similar references associated with the geolocation identifier in, for example, a look-up table (LUT). The Host UUID 206 is a unique identification number assigned to each server system 121. For example, a Host UUID 206 may be assigned to a server system 121 by cloud manager 112. Thus, each server system 121, e.g., each VM node 122A, 122B, 122C and/or 122D and/or each storage node 120A, 120B, 120C and/or 120D, may be assigned a respective unique identifier, e.g., Host UUID 206. Signature 208 may be provisioned in asset certificate 202 by, for example, attestation manager 110 and is configured to authenticate the asset certificate 202 itself.

Thus, asset certificate 202 and storage asset tag 114 are associated with a particular server system 121 and are configured to provide a secure geolocation identifier for each storage node 120 (and/or storage volume) included in or accessible to the network system 100. The asset certificate 202 and storage asset tag 114 are further configured to provide an indication of trust for each server system 121 hosting, housing, or otherwise providing a storage node. Attestation manager 110 is configured to initially generate and provision the asset certificate 202 and storage asset tag 114. Geolocation identifier(s) utilized in TAG 204 may be provided by, for example, an administrator via cloud manager 112. The storage asset tag 114 may then be utilized during operation to ensure that policy constraints, stored in e.g., policies 124, related to geolocation constraints of stored data are met.

For example, a policy 124 may establish that a VM and associated storage volumes must remain within the continental United States. In such instances, the block storage & VM manager 102 may examine the storage asset tag 114 logically associated with any candidate server system 121 to determine whether the server system 121 is located in the United States.

The geolocation constraints may be included in policy constraints included in policies 124 and may be set by, for example, a system administrator via cloud manager 112. Geolocation constraints may include, but are not limited to, that a geolocation of a storage node 120 and/or storage volume may correspond to a geolocation of a related VM node, that a geolocation of a storage node and/or storage volume may be set, that a geolocation of a storage node and/or storage volume may be within a tolerance (e.g., a specified distance or within a specified geopolitical boundary) of the geolocation of the related VM node, that a geolocation of a storage node and/or storage volume may be within a tolerance of the set geolocation, that a geolocation of a destination storage node and/or storage volume may correspond to a geolocation of a source storage node and/or storage volume, that a geolocation of the destination storage node and/or storage volume may be within a tolerance of a geolocation of the source storage node and/or storage volume, etc.

During operation, storage volumes may be manually or autonomously created, attached and/or migrated. Creation of a storage volume may include identifying one or more storage node(s) 120 meeting one or more associated policy constraints as determined by policies 124. The policy constraint(s) may include one or more geolocation constraints, as described herein. Whether the geolocation constraints are met may be determined based, at least in part, using a geolocation identifier. Block storage and VM manager 102, and, e.g., scheduler 104, is configured to identify storage node(s) 120 meeting all of the policy constraints and to then select a storage node 120 from the storage node(s) 120 meeting all of the policy constraints and having adequate storage capacity based on the requested storage volume. For example, location filters 106 may be configured to apply the policy constraints so as to reject storage node(s) 120 that do not meet one or more of the policy constraint(s). Thus, location filters 106 may be configured to reject storage node(s) 120 that do not meet one or more geolocation constraint(s). Block storage and VM manager 102 may be further configured to verify trust and node geolocation 210 of the selected storage node 120 and to create the storage volume on the trusted and verified storage node 120. The policy constraints may then be stored in the storage volume as metadata. The metadata may thus include an associated geolocation identifier.

Attaching a storage volume to a VM node 122 may be performed, for example, in response to a request from the VM node 122, e.g., block storage request 214. The VM node 122 may have an associated VM asset tag 115 that includes VM geolocation identifier. Block storage and VM manager 102, and, e.g., scheduler 104, is configured to identify storage node(s) 120 whose associated geolocation identifier(s) correspond to the requesting VM node 122 VM geolocation identifier. Similar to creation of a storage volume, block storage and VM manager 102, and, e.g., scheduler 104, is configured to identify storage node(s) 120 that meet all of the policy constraints based, at least in part, on the VM geolocation and to then select a storage node 120 from the storage node(s) 120 that meet all of the policy constraints that has adequate capacity for the storage volume. Block storage and VM manager 102 may then be configured to attach the requesting VM node 122 to the selected storage node 120 and/or storage volume. Block storage and VM manager 102 may be further configured to verify trust and node geolocation 210 of the storage node 120.

Data from a first storage node 120A and/or storage volume (“source storage node”) may be duplicated (i.e., copied) or migrated to a second storage node 120B and/or storage volume (“destination storage node”). Such duplication or migration may be performed for, for example, back-up storage, server system maintenance, at the direction of a VM, at the direction of a system user, at the direction of a system administrator, etc. Policy constraints may include constraining a geolocation of the destination storage node 120B to correspond to a geolocation of the source storage node 120A. Block storage and VM manager 102, and, e.g., scheduler 104, is configured to determine whether the destination storage node 120B meets all of the policy constraints of the source storage node 120A, including source storage node geolocation. If the destination storage node 120B meets all of the policy constraints and has adequate storage capacity available, block storage and VM manager 102 may then duplicate or migrate the data from the source storage node 120A to the destination storage node 120B and/or storage volume. Block storage and VM manager 102 may be further configured to verify trust and node geolocation 210 of the destination storage node 120B via attestation manager 110, as described herein. If the destination storage node 120B does not meet at least the geolocation constraint of the source storage node 120A, data migration or duplication between the nodes may be prohibited and the block storage and VM manager 102 may generate or signal (i.e., output) a geolocation error.

Thus, methods and systems consistent with the present disclosure are configured to implement geolocation constraints for block storage nodes associated with a cloud computing system. The methods and systems are configured to allow provisioning of block storage on server system(s) 121 that comply with given geolocation constraint(s) and to return an error if no such server system(s) 121 meeting designated policy constraints are available or if a specified server system 121 fails to comply with the given geolocation constraint. The geolocation of a storage node 120, a VM node 122, or the server system 121 hosting the storage node 120 or the VM node 122 may be identified using a geolocation identifier included in an asset tag that is stored on the server system 121 and protected by cryptographic techniques including a digital signature, hashing and secure storage. The methods and systems are further configured to verify a trust status of each of the block storage nodes, as described herein.

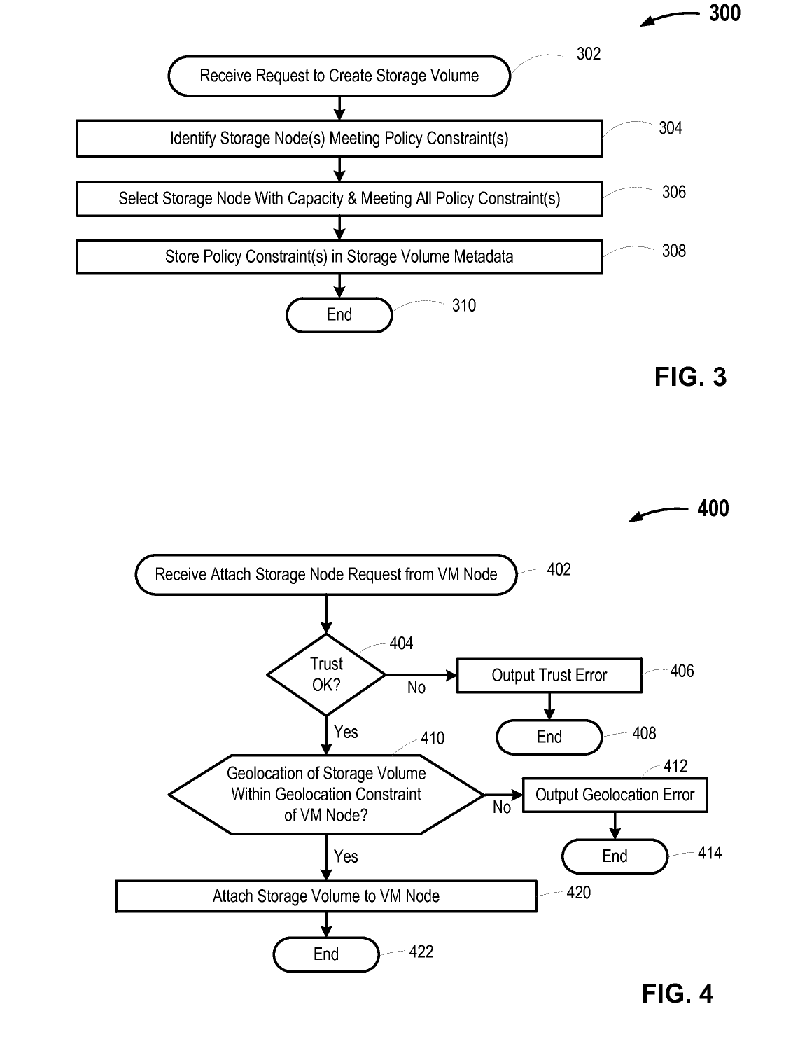

FIG. 3 illustrates a flowchart 300 of storage volume create operations according to one example embodiment consistent with the present disclosure. Operations of flowchart 300 may be performed by, for example, block storage and VM manager 102 and/or attestation manager 110. Operation 302 includes a receiving request to create a storage volume. Such a request may be generated by a VM, by a system administrator, by an application executing on the network, or by a system user. Such a request may include policies 124 that include, but are not limited to, one or more trust constraints, one or more geolocation constraints, or any number or combination thereof. Operation 304 includes identifying one or more storage node(s) 120 within the network 105 that meet the constraints included in the policies 124. Operation 306 includes selecting a storage node 120 with capacity meeting all system and policy constraints. Operation 308 includes storing the policy constraints used to select the storage node 120 in storage volume metadata. Program flow may then end at operation 310.

FIG. 4 illustrates a flowchart 400 of storage volume attach operations according to one example embodiment consistent with the present disclosure. Operations of flowchart 400 may be performed by, for example, block storage and VM manager 102 and/or attestation manager 110. Operation 402 includes receiving a request from a VM node 122 to attach to a storage volume. Whether a trust status of the storage volume or the server system 121 hosting the storage volume is acceptable may be determined at operation 404. If the trust status of the storage volume or the server system 121 hosting the storage volume is not acceptable, the system generates a trust error that may be output at operation 406. Program flow may then end at operation 408. If the trust status of the storage volume or the server system 121 hosting the storage volume is acceptable, whether a geolocation of the storage volume or the server system 121 hosting the storage volume is within a geolocation constraint of the VM node 122 may be determined at operation 410. If the geolocation of the storage volume or the server system 121 hosting the storage volume is not within the geolocation constraint of the VM node, a geolocation error may be output at operation 412. Program flow may then end at operation 414. If the geolocation of the storage volume or the server system 121 hosting the storage volume is within the geolocation constraint of the VM node 122, the storage volume may be attached to the VM node 122 at operation 420. Program flow may then end at operation 422.

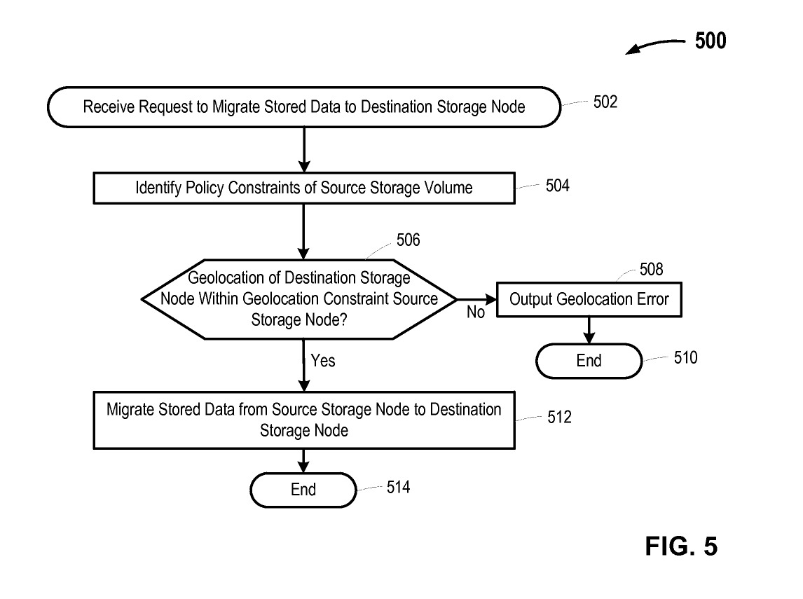

FIG. 5 illustrates a flowchart 500 of migration operations according to one example embodiment consistent with the present disclosure. Operations of flowchart 500 may be performed by, for example, block storage and VM manager 102 and/or attestation manager 110. Operation 502 includes receiving a request to migrate stored data to a destination storage node 120B. Operation 504 includes identifying policy constraints of a source storage volume. Whether a geolocation of the destination storage node 120B is within a geolocation constraint of the source storage node 120A may be determined at operation 506. If the geolocation of the destination storage node 120B is not within the geolocation constraint of the source storage node 120A, a geolocation error may be output at operation 508. Program flow may then end at operation 510. If the geolocation of the destination storage node 120B is within the geolocation constraint of the source storage node 120A, stored data may be migrated from the source storage node 120A to the destination storage node 120B at operation 512. Program flow may then end at operation 514.

Nodes 120 and/or nodes 122 may further include an operating system (OS, not shown) to manage system resources and control tasks that are run on, e.g., node 102. For example, the OS may be implemented using Microsoft Windows, HP-UX, Linux, or UNIX, although other operating systems may be used. In some embodiments, the OS may be replaced by a virtual machine monitor (or hypervisor) which may provide a layer of abstraction for underlying hardware to various operating systems (virtual machines) running on one or more processing units.

The system 100 memory may comprise one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may comprise other and/or later-developed types of computer-readable memory.

Embodiments of the operations described herein may be implemented in a system that includes at least one tangible computer-readable storage device having stored thereon, individually or in combination, instructions that when executed by one or more processors perform the methods. The processor may include, for example, a processing unit and/or programmable circuitry in the network controller 104, system processor 106 and/or other processing unit or programmable circuitry. Thus, it is intended that operations according to the methods described herein may be distributed across a plurality of physical devices, such as processing structures at several different physical locations. The storage device may include any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage device suitable for storing electronic instructions.

TPM 116, 118 may comply or be compatible with the Trusted Platform Module standard, published July 2007 by JTC1, a joint committee of the International Organization for Standardization (ISO), and IEC, the International Electrotechnical Commission, entitled the “Trusted Computing Group Trusted Platform Module specification Version 1.2” as ISO/IEC standard 11889, and/or later versions of this standard.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

The following examples pertain to additional embodiments of technologies disclosed herein.

According to example 1, there is provided a system that provides a storage volume compliant with workload location requirements. The system includes a processor that may be communicably coupled to a network. The processor receives receive a request generated by a network connected device to create a storage volume on a storage node, the request including at least one storage volume parameter and a geographical policy criterion provided by the respective network connected device. The processor further selects a number of destination network connected storage devices, each of the selected number of destination network connected storage devices meeting the geographical policy criterion and hosting at least one storage node. The processor also creates the storage volume on at least one storage node hosted by at least one of the selected number of destination network connected storage devices.

Example 2 may include the elements of example 1 where to select a number of destination network connected storage devices, each of the selected number of destination network connected storage devices meeting the geographical policy criterion and hosting at least one storage node, the processor identifies a number of candidate network connected storage devices, each of the candidate network connected storage devices including at least one storage node satisfying the at least one storage volume parameter. The processor may additionally select the number of destination network connected storage devices from the identified number of candidate network connected storage devices.

Example 3 may include elements of example 2 where to select the number of destination network connected storage devices from the identified number of candidate network connected storage devices, the processor determines a value indicative of a level of trustworthiness for each respective one of the number of candidate network connected storage devices. The processor also selects the number of destination network connected storage devices from the identified number of candidate network connected storage devices that have a determined value indicative of a level of trustworthiness that exceeds a defined threshold.

Example 4 may include elements of example 3 and the processor additionally receives from at least one trusted component in each of the number of candidate network connected storage devices, data representative of an asset tag logically associated with the respective candidate network connected storage device. The processor also verifies at least a portion of the data representative of the asset tag logically associated with each respective one of the candidate network connected storage devices. The processor also determines, based at least in part on the data representative of the asset tag logically associated with the respective candidate network connected storage device, the value indicative of the level of trustworthiness and a value indicative of a level of geographical policy compliance for each respective one of the number of candidate network connected storage devices.

Example 5 may include elements of any of examples 1 through 4 where the processor receives from a network connected device that includes a user interface, a request provided by a user to create the storage volume. The processor also receives via the network connected device that includes the user interface, the at least one geographical policy criterion included with the respective request to create the storage volume.

Example 6 may include elements of examples 1 through 4 where the processor receives from a network connected device that includes a virtual machine, an autonomously generated request to create the storage volume. The processor also receives from the virtual machine the at least one autonomously generated geographical policy criterion included with the respective request to create the storage volume.

Example 7 may include elements of any of examples 1 through 4 where the geographic policy criterion includes data representative of at least one of: a city, a boundary, a state, a province, a country, a geographic area, a continent, a range of global positioning system coordinates, or a range of longitude and latitude values logically associated with the respective destination network connected storage device hosting the at least one destination storage node.

Example 8 may include elements of any of examples 1 through 4 where to receive a request generated by a network connected device to create a storage volume on a storage node, the request including at least one storage volume parameter and a geographical policy criterion provided by the respective network connected device, the processor receives a request to create a storage volume at a storage node that includes an instruction to migrate an existing storage volume from a first network connected storage device hosting a first storage node to a second storage device hosting a network connected second storage node.

According to example 9, there is provided a method of providing compliance with workload boundary and location requirements. The method includes receiving, by a processor, a request to create a storage volume on a storage node, the request including at least one storage volume parameter and at least one geographical policy criterion logically associated with an initiator of the request. The method also includes selecting, by the processor, a number of destination network connected storage devices, each of the selected number of destination network connected storage devices meeting the geographical policy criterion and hosting at least one storage node. The method further includes creating, by the processor, the storage volume on at least one storage node hosted by at least one of the number of destination network connected devices.

Example 10 may include elements of example 9 where selecting a number of destination network connected storage devices, each of the selected number of destination network connected storage devices meeting the geographical policy criterion and hosting at least one storage node may include: identifying, by the processor, a number of candidate network connected storage devices, each of the candidate network connected storage devices including at least one storage node satisfying the at least one storage volume parameter; and selecting, by the processor, the number of destination network connected storage devices from the identified number of candidate network connected storage devices.

Example 11 may include elements of example 9 where selecting the number of destination network connected storage devices from the identified number of candidate network connected storage devices comprises: determining, by the processor, a value indicative of a level of trustworthiness for each respective one of the number of candidate network connected storage devices; and selecting the number of destination network connected storage device from the identified number of candidate network connected storages devices that have a determined value indicative of a level of trustworthiness that satisfies at least one defined criterion.

Example 12 may include elements of example 11 where determining a value indicative of a level of trustworthiness for each respective one of the number of candidate network connected storage devices may include: receiving, from at least one trusted component in each of the number of candidate network connected storage devices, data representative of an asset tag logically associated with the respective candidate network connected storage device. The method may also include verifying, by the processor, at least a portion of the data representative of the asset tag logically associated with each respective one of the candidate network connected storage devices. The method may additionally include determining, by the processor, based at least in part on the data representative of the asset tag logically associated with the respective candidate network connected storage device, the value indicative of the level of trustworthiness and a value indicative of a level of geographical policy compliance for each respective one of the number of candidate network connected storage devices.

Example 13 may include elements of any of examples 9 through 12 where receiving a request to create a storage volume on a storage node may include receiving from a communicably coupled network connected device that includes a user interface, a user entered request to create a storage volume at the storage node, the user entered request including at least one user supplied storage volume parameter and at least one user supplied geographical policy criterion.

Example 14 may include elements of any of examples 9 through 12 where receiving a request to create a storage volume on a storage node may include receiving, from a communicably coupled network connected device, an autonomously generated request to create a storage volume at the storage node, the autonomously generated request including at least one autonomously generated storage volume parameter and at least one autonomously generated geographical policy criterion.

Example 15 may include elements of example 14 where receiving an autonomously generated request to create a storage volume at the storage node may include receiving, from a communicably coupled virtual machine, an autonomously generated request to create the storage volume at the storage node.

Example 16 may include elements of any of examples 9 through 12 where selecting a number of destination network connected storage devices, each of the selected number of destination network connected storage devices meeting the geographical policy criterion and hosting at least one storage node may include receiving, from a trusted component in each respective one of the number of destination network connected storage devices, data representative of a geolocation logically associated with the respective storage device. The method may also include verifying, by the processor, the data representative of the geolocation for each respective one of the storage devices with a geolocation policy criteria. The method may further include determining, by the processor, the value indicative of the level of policy compliance for each communicably coupled storage device based at least in part on the verification of the geolocation of the respective storage device.

Example 17 may include elements of any of examples 9 through 12 where selecting a number of destination network connected storage devices, each of the selected number of destination network connected storage devices meeting the geographical policy criterion and hosting at least one storage node may include receiving, from at least one trusted component in each communicably coupled storage device hosting at least one of the candidate storage nodes, data representative of at least one of: a city, a boundary, a state, a province, a country, a geographic area, a continent, a range of global positioning system coordinates, or a range of longitude and latitude values logically associated with the respective storage device.

Example 18 may include elements of any of examples 9 through 12 where receiving a request to create a storage volume on a storage node, the request including at least one storage volume parameter and at least one geographical policy criterion logically associated with an initiator of the request may include receiving, by the processor, the request to create the storage volume on the storage node, the request including at least one geographic policy requirement logically associated with the initiator of the request, the at least one geographic policy requirement including at least one of: a geolocation control or a political boundary logically associated with the storage volume.

9. Example 19 may include elements of any of examples 9 through 12 where receiving a request to create a storage volume on a storage node may include receiving, by the processor, a request to migrate an existing storage volume from a first storage node meeting a first geographic policy criterion to a second storage node meeting the first geographic policy criterion.

According to example 20, there is provided a storage device containing machine readable instructions that when executed by a processor, cause the processor to receive a request to create a storage volume on a storage node, the request including at least one storage volume parameter and at least one geographical policy criterion logically associated with an initiator of the request. The machine readable instructions further cause the processor to select a number of destination network connected storage devices, each of the selected number of destination network connected storage devices meeting the geographical policy criterion and hosting at least one storage node. The machine readable instructions further cause the at least one processor to create the storage volume on at least one storage node hosted by at least one of the number of destination network connected devices.

Example 21 may include elements of example 20 where the machine executable instructions that cause the processor to select a number of destination network connected storage devices, each of the selected number of destination network connected storage devices meeting the geographical policy criterion and hosting at least one storage node further cause the processor to identify a number of candidate network connected storage devices, each of the candidate network connected storage devices including at least one storage node satisfying the at least one storage volume parameter; and select the number of destination network connected storage devices from the identified number of candidate network connected storage devices.

Example 22 may include elements of example 21 where the machine executable instructions that cause the at least one processor to select the number of destination network connected storage devices from the identified number of candidate network connected storage devices further cause the processor to determine a value indicative of a level of trustworthiness for each respective one of the number of candidate network connected storage devices. The instructions may additionally cause the processor to select the number of destination network connected storage devices from the identified number of candidate network connected storage devices that have a determined value indicative of a level of trustworthiness that exceeds a defined threshold.

the storage device instructions that cause the processor to receive a request to create a storage volume on a storage node further cause the processor to receive the request autonomously generated by a communicably coupled network device.

Example 23 may include elements of example 22 where the storage device instructions that cause the processor to receive a request to create a storage volume on a storage node, the request including at least one storage volume parameter and at least one policy criteria logically associated with an initiator of the request further cause the processor to receive the request to create a storage volume on the storage node from the communicably coupled network device, the request including at least one storage volume parameter generated by the communicably coupled network device and at least one policy criteria logically associated with the communicably coupled network device.

Example 24 may include elements of example 22 where the storage device instructions that cause the processor to receive a request generated autonomously by a communicably coupled network device further cause the processor to receive a request generated autonomously by a communicably coupled virtual machine.

Example 25 may include elements of example 24 where the storage device instructions that cause the processor to receive a request to create a storage volume on a storage node, the request including at least one storage volume parameter and at least one policy criteria logically associated with an initiator of the request further cause the processor to receive the request to create a storage volume on the storage node from the communicably coupled network device, the request including at least one storage volume parameter generated by the virtual machine and at least one policy criteria logically associated with the virtual machine.

Example 26 may include elements of example 20 where the storage device instructions that cause the processor to determine a value indicative of a level of trustworthiness of at least some of the candidate storage nodes further cause the processor to obtain from a trusted component in each communicably coupled storage device hosting at least one of the candidate storage nodes, data representative of an asset tag logically associated with the respective server. The instructions further cause the processor to verify a hash of the asset tag for each respective one of the servers with a known valid hash of the asset tag for each respective one of the servers. The instructions further cause the processor to determine a value indicative of a level of trustworthiness of each communicably coupled server based at least in part on the verification of the asset tag hash for the respective server.

Example 27 may include elements of any of claims 20 through 26 where the storage device instructions that cause the processor to determine a value indicative of a level of policy compliance of at least some of the candidate storage nodes further cause the processor to obtain from a trusted component in each communicably coupled storage device hosting at least one of the candidate storage nodes, data representative of a geolocation logically associated with the respective server. The instructions may further cause the processor to verify the data representative of the geolocation for each respective one of the storage devices with a geolocation policy criteria. The instructions may additionally cause the processor to determine the value indicative of the level of policy compliance for each communicably coupled storage device based at least in part on the verification of the geolocation of the respective storage device.

Example 28 may include elements of claim 27 where the storage device instructions that cause the processor to obtain from a trusted component in each communicably coupled storage device hosting at least one of the candidate storage nodes, data representative of a geolocation logically associated with the respective storage device further cause the processor to obtain from a trusted component in each communicably coupled storage device hosting at least one of the candidate storage nodes, data representative of at least one of: a city, a boundary, a state, a province, a country, a geographic area, a continent, a range of global positioning system coordinates, or a range of longitude and latitude values logically associated with the respective storage device.

Example 29 may include elements of any of claims 20 through 26 where the storage device instructions that cause the processor to receive a request to create a storage volume on a storage node, the request including at least one policy requirement logically associated with an initiator of the request further cause the processor to receive the request to create the storage volume on the storage node, the request including at least one policy requirement logically associated with the initiator of the request, the at least one policy requirement including at least one of: a location control or a boundary control placed on the storage volume.

Example 30 may include elements of any of claims 20 through 26 where the storage device instructions that cause the processor to receive a request to create a storage volume on a storage node further cause the processor to receive a request to migrate an existing storage volume from a first storage node to a second storage node.

According to example 31, there is provided a system that provides compliance with workload boundary and location requirements. The system may include a plurality of storage devices, a network communicably coupling the plurality of storage devices, and at least one processor coupled to the network. The at least one processor may, responsive to receipt of a request to create a new storage volume, determine one or more storage volume policies, the one or more storage volume policies including a storage volume geolocation policy. The at least one processor may additionally locate at least one candidate storage device in the plurality of storage devices, the candidate storage device having stored in a trusted location a logically associated asset tag that includes geolocation data compliant with the storage volume geolocation policy. The at least one processor may additionally create the at least one storage volume in a storage node on the at least one candidate storage device.

Example 32 may include elements of example 31, where the at least one processor may further, responsive to the request to create the new storage volume, verify a trustworthiness of at least some of the plurality of storage devices based, at least in part, on a security value retained in the asset tag logically associated with the respective storage device.

Example 33 may include elements of example 32 where the at least one processor may further identify at least one candidate storage device in the plurality of storage devices, the candidate storage device having been verified as trustworthy and having stored in the trusted location the logically associated asset tag that includes geolocation data compliant with the storage volume geolocation policy.

Example 34 may include elements of example 31, where the at least one processor may further determine one or more storage volume policies responsive to receipt of the request from a virtual machine having one or more logically associated virtual machine policies and executing on at least one of the plurality of storage devices to at least one of: create a new storage volume, attach a storage volume to an existing VM, or migrate a storage volume from a first storage node to a second storage node, wherein the one or more storage volume policies align at least in part with one or more virtual machine policies.

Example 35 may include elements of example 31, where the at least one processor may further determine one or more storage volume policies responsive to receipt of the request from a system user to at least one of: create a new storage volume, attach a storage volume to an existing VM, or migrate a storage volume from a first storage node to a second storage node.

According to example 36, there is provided a method of providing compliance with workload boundary and location requirements. The method can include determining, by a processor communicably coupled via a network to a plurality of storage devices, one or more storage volume policies including at least a storage volume geolocation policy responsive to receipt of a request to create a new storage volume. The method can further include locating, by the processor, at least one candidate storage device, the candidate storage device having stored thereupon in a trusted location a logically associated asset tag that includes geolocation data compliant with the storage volume geolocation policy. The method may further include creating, by the processor, the at least one storage volume in a storage node on the candidate storage device.

Example 37 may include elements of example 36 and may additionally include verifying, by the processor, a trustworthiness of at least some of the plurality of storage devices based, at least in part, on a security value retained in the asset tag logically associated with the respective storage device.

Example 38 may include elements of example 37 and may additionally include identifying a candidate storage device in the plurality of storage devices, the candidate storage device having been verified as trustworthy and having stored in the trusted location the logically associated asset tag that includes geolocation data compliant with the storage volume geolocation policy.

Example 39 may include elements of example 36 and may additionally include determining one or more storage volume policies responsive to receipt of the request from a virtual machine executing on at least one of the plurality of storage devices to create a new storage volume, attach a storage volume to an existing VM, or migrate a storage volume from a first storage node to a second storage node.

Example 40 may include elements of example 36 and may additionally include determining one or more storage volume policies responsive to receipt of the request from a system user to at least one of: create a new storage volume, attach a storage volume to an existing VM, or migrate a storage volume from a first storage node to a second storage node.

According to example 41, there is provided a machine-readable medium comprising one or more instructions that when executed by a processor cause the processor to determine one or more storage volume policies including at least a storage volume geolocation policy responsive to receipt of a request to create a new storage volume. The machine-readable instructions may further cause the at least one processor to locate at least one candidate storage device, the candidate storage device having stored thereupon in a trusted location a logically associated asset tag that includes geolocation data compliant with the storage volume geolocation policy. The machine-readable instructions may further cause the at least one processor to create the at least one storage volume in a storage node on the candidate storage device.

Example 42 may include elements of example 41 and may include additional instructions that cause the processor to verify a trustworthiness of at least some of the plurality of storage devices based, at least in part, on a security value retained in the asset tag logically associated with the respective storage device.

Example 43 may include elements of example 42 and may include additional instructions that further cause the processor to identify a candidate storage device in the plurality of storage devices, the candidate storage device having been verified as trustworthy and having stored in the trusted location the logically associated asset tag that includes geolocation data compliant with the storage volume geolocation policy.

Example 44 may include elements of example 41 and may include additional instructions that further cause the processor to determine one or more storage volume policies responsive to receipt of the request from a virtual machine executing on at least one of the plurality of storage devices to create a new storage volume, attach a storage volume to an existing VM, or migrate a storage volume from a first storage node to a second storage node.

Example 45 may include elements of example 41 and may include additional instructions that further cause the processor to determine one or more storage volume policies responsive to receipt of the request from a system user to at least one of: create a new storage volume, attach a storage volume to an existing VM, or migrate a storage volume from a first storage node to a second storage node.

According to example 46, there is provided a system for providing compliance with workload boundary and location requirements. The system includes a means for determining one or more storage volume policies including at least a storage volume geolocation policy responsive to receipt of a request to create a new storage volume. The system further includes a means for locating at least one candidate storage device, the candidate storage device having stored thereupon in a trusted location a logically associated asset tag that includes geolocation data compliant with the storage volume geolocation policy. The system additionally includes a means for creating the at least one storage volume in a storage node on the candidate storage device.

Example 47 may include elements of example 46, and may additionally include a means for verifying a trustworthiness of at least some of the plurality of storage devices based, at least in part, on a security value retained in the asset tag logically associated with the respective storage device.

Example 48 may include elements of any of examples 46 or 47 and may additionally include a means for identifying a candidate storage device in the plurality of storage devices, the candidate storage device having been verified as trustworthy and having stored in the trusted location the logically associated asset tag that includes geolocation data compliant with the storage volume geolocation policy.

Example 49 may include elements of any of examples 46 or 47 and may additionally include a means for determining one or more storage volume policies responsive to receipt of the request from a virtual machine executing on at least one of the plurality of storage devices to create a new storage volume, attach a storage volume to an existing VM, or migrate a storage volume from a first storage node to a second storage node.

Example 50 may include elements of any of claim 46 or 47 and may additionally include a means for determining one or more storage volume policies responsive to receipt of the request from a system user to at least one of: create a new storage volume, attach a storage volume to an existing VM, or migrate a storage volume from a first storage node to a second storage node.

According to example 51, there is provided a system for providing compliance with workload boundary and location requirements, the system being arranged to perform the method of any of examples 36 through 40.

According to example 52, there is provided a chipset arranged to perform the method of any of examples 36 through 40.

According to example 53, there is provided at least one machine-readable storage device that includes a plurality of instructions that, in response to be being executed on a computing device, cause the computing device to carry out the method according to any of examples 36 through 40.

According to example 54, there is provided a device configured for providing compliance with workload boundary and location requirements, the device being arranged to perform the method of any of examples 36 through 40.

According to example 55, there is provided a system for providing compliance with workload boundary and location requirements, the system being arranged to perform the method of any of the claims 9 through 19.

According to example 56, there is provided a chipset arranged to perform the method of any of the claims 9 through 19.

According to example 57, there is provided at least one machine readable medium comprising a plurality of instructions that, in response to be being executed on a computing device, cause the computing device to carry out the method according to any of the claims 9 through 19.

According to example 58, there is provided a device configured for providing compliance with workload boundary and location requirements, the device being arranged to perform the method of any of the claims 9 through 19.

“Module,” as used herein, may comprise, singly or in any combination circuitry and/or code and/or instructions sets (e.g., software, firmware, etc.). “Circuitry,” as used in any embodiment herein, may comprise, for example, singly or in any combination, hardwired circuitry, programmable circuitry, state machine circuitry, and/or firmware that stores instructions executed by programmable circuitry. The circuitry may be embodied as an integrated circuit, such as an integrated circuit chip. Thus, the network controller may be embodied as a stand-alone integrated circuit or may be incorporated as one of several components on an integrated circuit. In some embodiments, the various components, circuits and modules of the network controller or other systems may be combined in a system-on-a-chip (SoC) architecture.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A system that provides a storage volume compliant with workload location requirements, the system comprising:
a processor communicably coupleable to a network, the processor to:
receive a request generated by a network connected device to create a storage volume on a storage node, the request including at least one storage volume parameter and a geographical policy criterion provided by the respective network connected device;
select a number of destination network connected storage devices, each of the selected number of destination network connected storage devices meeting the geographical policy criterion and hosting at least one storage node; and
create the storage volume on at least one storage node hosted by at least one of the selected number of destination network connected storage devices.

2. The system of claim 1 wherein to select a number of destination network connected storage devices, each of the selected number of destination network connected storage devices meeting the geographical policy criterion and hosting at least one storage node, the processor to:
identify a number of candidate network connected storage devices, each of the candidate network connected storage devices including at least one storage node satisfying the at least one storage volume parameter; and
select the number of destination network connected storage devices from the identified number of candidate network connected storage devices.

3. The system of claim 2 wherein to select the number of destination network connected storage devices from the identified number of candidate network connected storage devices, the processor to:
determine a value indicative of a level of trustworthiness for each respective one of the number of candidate network connected storage devices; and
select the number of destination network connected storage devices from the identified number of candidate network connected storage devices that have a determined value indicative of a level of trustworthiness that exceeds a defined threshold.

4. The system of claim 3 wherein to select the number of destination network connected storage devices from the identified number of candidate network connected storage devices that have a determined value indicative of a level of trustworthiness that exceeds a defined threshold, the processor to:
receive from at least one trusted component in each of the number of candidate network connected storage devices, data representative of a hash of an asset tag logically associated with the respective candidate network connected storage device;
verify at least a portion of the data representative of the hash of the asset tag logically associated with each respective one of the candidate network connected storage devices;
determine, based at least in part on the verification of the data representative of the hash of the asset tag logically associated with the respective candidate network connected storage device, the value indicative of the level of trustworthiness and a value indicative of a level of geographical policy compliance for each respective one of the number of candidate network connected storage devices.

5. The system of claim 1 wherein to receive a request generated by a network connected device to create a storage volume on a storage node, the processor to:
receive from a network connected device that includes a user interface, a request provided by a user to create the storage volume; and
receive via the network connected device that includes the user interface, the at least one geographical policy criterion included with the respective request to create the storage volume.

6. The system of claim 1 wherein to receive a request generated by a network connected device to create a storage volume on a storage node, the processor to:
receive from a network connected device that includes a virtual machine, an autonomously generated request to create the storage volume;
receive from the virtual machine the at least one autonomously generated geographical policy criterion included with the respective request to create the storage volume.

7. The system of claim 1 wherein the geographic policy criterion includes data representative of at least one of: a city, a boundary, a state, a province, a country, a geographic area, a continent, a range of global positioning system coordinates, or a range of longitude and latitude values logically associated with the respective destination network connected storage device hosting the at least one destination storage node.

8. The system of claim 1 wherein to receive a request generated by a network connected device to create a storage volume on a storage node, the request including at least one storage volume parameter and a geographical policy criterion provided by the respective network connected device, the processor to:
receive a request to create a storage volume at a storage node that includes an instruction to migrate an existing storage volume from a first network connected storage device hosting a first storage node to a second storage device hosting a network connected second storage node.

9. A method of providing compliance with workload boundary requirements, the method comprising:
receiving, by a processor, a request to create a storage volume on a storage node, the request including at least one storage volume parameter and at least one geographical policy criterion logically associated with an initiator of the request;
selecting, by the processor, a number of destination network connected storage devices, each of the selected number of destination network connected storage devices meeting the geographical policy criterion and hosting at least one storage node; and
creating, by the processor, the storage volume on at least one storage node hosted by at least one of the number of destination network connected devices.

10. The method of claim 9 wherein selecting a number of destination network connected storage devices, each of the selected number of destination network connected storage devices meeting the geographical policy criterion and hosting at least one storage node comprises:
identifying, by the processor, a number of candidate network connected storage devices, each of the candidate network connected storage devices including at least one storage node satisfying the at least one storage volume parameter; and
selecting, by the processor, the number of destination network connected storage devices from the identified number of candidate network connected storage devices.

11. The method of claim 10 wherein selecting the number of destination network connected storage devices from the identified number of candidate network connected storage devices comprises:
determining, by the processor, a value indicative of a level of trustworthiness for each respective one of the number of candidate network connected storage devices;
selecting the number of destination network connected storage device from the identified number of candidate network connected storages devices that have a determined value indicative of a level of trustworthiness that satisfies at least one defined criterion.

12. The method of claim 11 wherein determining a value indicative of a level of trustworthiness for each respective one of the number of candidate network connected storage devices comprises:
receiving, from at least one trusted component in each of the number of candidate network connected storage devices, data representative of an asset tag logically associated with the respective candidate network connected storage device;
verifying, by the processor, at least a portion of the data representative of the asset tag logically associated with each respective one of the candidate network connected storage devices;
determining, by the processor, based at least in part on the data representative of the asset tag logically associated with the respective candidate network connected storage device, the value indicative of the level of trustworthiness and a value indicative of a level of geographical policy compliance for each respective one of the number of candidate network connected storage devices.

13. The method of claim 9 wherein receiving a request to create a storage volume on a storage node comprises:
receiving from a communicably coupled network connected device that includes a user interface, a user entered request to create a storage volume at the storage node, the user entered request including at least one user supplied storage volume parameter and at least one user supplied geographical policy criterion.

14. The method of claim 9 wherein receiving a request to create a storage volume on a storage node comprises:
receiving, from a communicably coupled network connected device, an autonomously generated request to create a storage volume at the storage node, the autonomously generated request including at least one autonomously generated storage volume parameter and at least one autonomously generated geographical policy criterion.

15. The method of claim 14 wherein receiving an autonomously generated request to create a storage volume at the storage node comprises:
receiving, from a communicably coupled virtual machine, an autonomously generated request to create the storage volume at the storage node.

16. The method of claim 9 wherein selecting a number of destination network connected storage devices, each of the selected number of destination network connected storage devices meeting the geographical policy criterion and hosting at least one storage node comprises:
receiving, from a trusted component in each respective one of the number of destination network connected storage devices, data representative of a geolocation logically associated with the respective storage device;
verifying, by the processor, the data representative of the geolocation for each respective one of the storage devices with a geolocation policy criteria;
determining, by the processor, the value indicative of the level of policy compliance for each communicably coupled storage device based at least in part on the verification of the geolocation of the respective storage device.

17. The method of claim 9 wherein selecting a number of destination network connected storage devices, each of the selected number of destination network connected storage devices meeting the geographical policy criterion and hosting at least one storage node comprises:
receiving, from at least one trusted component in each communicably coupled storage device hosting at least one of the candidate storage nodes, data representative of at least one of: a city, a boundary, a state, a province, a country, a geographic area, a continent, a range of global positioning system coordinates, or a range of longitude and latitude values logically associated with the respective storage device.

18. The method of claim 9 wherein receiving a request to create a storage volume on a storage node, the request including at least one storage volume parameter and at least one geographical policy criterion logically associated with an initiator of the request comprises:
receiving, by the processor, the request to create the storage volume on the storage node, the request including at least one geographic policy requirement logically associated with the initiator of the request, the at least one geographic policy requirement including at least one of: a geolocation control or a political boundary logically associated with the storage volume.

19. The method of claim 9 wherein receiving a request to create a storage volume on a storage node comprises:
receiving, by the processor, a request to migrate an existing storage volume from a first storage node meeting a first geographic policy criterion to a second storage node meeting the first geographic policy criterion.

20. A storage device containing machine readable instructions that when executed by a processor, cause the processor to:
receive a request to create a storage volume on a storage node, the request including at least one storage volume parameter and at least one geographical policy criterion logically associated with an initiator of the request;
select a number of destination network connected storage devices, each of the selected number of destination network connected storage devices meeting the geographical policy criterion and hosting at least one storage node; and
create the storage volume on at least one storage node hosted by at least one of the number of destination network connected devices.

21. The storage device of claim 20 wherein the machine executable instructions that cause the processor to select a number of destination network connected storage devices, each of the selected number of destination network connected storage devices meeting the geographical policy criterion and hosting at least one storage node further cause the processor to:
identify a number of candidate network connected storage devices, each of the candidate network connected storage devices including at least one storage node satisfying the at least one storage volume parameter; and
select the number of destination network connected storage devices from the identified number of candidate network connected storage devices.

22. The storage device of claim 21 wherein the machine executable instructions that cause the at least one processor to select the number of destination network connected storage devices from the identified number of candidate network connected storage devices further cause the processor to:
determine a value indicative of a level of trustworthiness for each respective one of the number of candidate network connected storage devices; and
select the number of destination network connected storage devices from the identified number of candidate network connected storage devices that have a determined value indicative of a level of trustworthiness that exceeds a defined threshold.

23. A system for providing compliance with workload location requirements, the system comprising:
a means for receiving a request to create a storage volume on a storage node, the request including at least one storage volume parameter and at least one geographical policy criterion logically associated with an initiator of the request;
a means for selecting a number of destination network connected storage devices, each of the selected number of destination network connected storage devices meeting the geographical policy criterion and hosting at least one storage node; and
a means for creating the storage volume on at least one storage node hosted by at least one of the number of destination network connected devices.

24. The system of claim 23 wherein the means for selecting a number of destination network connected storage devices, each of the selected number of destination network connected storage devices meeting the geographical policy criterion and hosting at least one storage node comprises:
a means for identifying a number of candidate network connected storage devices, each of the candidate network connected storage devices including at least one storage node satisfying the at least one storage volume parameter; and
a means for selecting the number of destination network connected storage devices from the identified number of candidate network connected storage devices.

25. The system of claim 24 wherein the means for selecting the number of destination network connected storage devices from the identified number of candidate network connected storage devices comprises:
a means for determining a value indicative of a level of trustworthiness for each respective one of the number of candidate network connected storage devices;
a means for selecting the number of destination network connected storage device from the identified number of candidate network connected storages devices that have a determined value indicative of a level of trustworthiness that satisfies at least one defined criterion.
